(19) United States
(12) Patent Application Publication
(10) Pub. No.: US 2020/0314046 A1
(43) Pub. Date: Oct. 1, 2020

(54) SPATIAL MESSAGING AND CONTENT SHARING METHOD, AND SYSTEM THEREFOR

(71) Applicant: NAVER LABS CORPORATION, Seongnam-si (KR)

(72) Inventor: Jeanie JUNG, Seongnam-si (KR)

(21) Appl. No.: 16/900,177

(22) Filed: Jun. 12, 2020

Related U.S. Application Data
(63) Continuation of application No. PCT/KR2018/015669, filed on Dec. 11, 2018.

(30) Foreign Application Priority Data
Dec. 15, 2017 (KR) 10-2017-0172915

(51) Int. Cl. H04L 12/58; G06T 19/00; G06F 16/9537

(52) U.S. Cl. CPC H04L 51/10; H04L 51/08; G06F 16/9537; G06T 19/006

(57) ABSTRACT

An information sharing method includes the steps of creating a virtual space by assigning a unique coordinate value to a location specified by an electronic device; linking augmented reality (AR) content to the virtual space; and sharing the AR content linked to the virtual space via the coordinate value of the virtual space.

### CROSS-REFERENCE TO RELATED APPLICATIONS

This is a continuation application of International Application No. PCT/KR2018/015669, filed Dec. 11, 2018, which claims the benefit of Korean Patent Application No. 10-2017-0172915, filed Dec. 15, 2017.

### BACKGROUND OF THE INVENTION

### Field of Invention

Example embodiments of the following description relate to technology for making space an information platform.

### Description of Related Art

Currently, efforts have been made to provide a variety of services by applying augmented reality (AR). For example, technology for providing an AR experience function capable of actually demonstrating a product when shopping is disclosed in Korean Patent Laid-Open Publication NO. 10-2016-0096546 (published on Aug. 16, 2016).

With the development in such AR-based technology, space has emerged as a next-generation computing system, but the simple augmentation of content is merely to provide momentary fun and events.

### BRIEF SUMMARY OF THE INVENTION

One or more example embodiments of the present invention provide an information platform for spatial messaging and content sharing in combination with augmented reality (AR) and localization.

One or more example embodiments provide a method and system that may create a virtual space having a unique coordinate value, may link AR content to the corresponding space, and may share the space with users.

According to at least one example embodiment, there is provided an information sharing method performed by a computer system, the information sharing method including creating a virtual space by assigning a unique coordinate value to a location specified by an electronic device; linking augmented reality (AR) content to the virtual space; and sharing the AR content linked to the virtual space through the coordinate value of the virtual space.

According to an aspect of the present invention, the creating of the virtual space may include verifying and coordinating the specified location through a map mapping method or a deep learning-based vision technology.

According to another aspect, the creating of the virtual space may include assigning a unique coordinate value for each set of subdivided location coordinates of a map or grouping the location coordinates based on a desired unit and assigning the unique coordinate value for each grouped unit.

According to still another aspect, the linking of the AR content to the virtual space may include storing a parameter of content authored through an authoring function in association with the coordinate value assigned to the virtual space.

According to still another aspect, the linking of the AR content to the virtual space may include storing tracking information that includes a motion, a rotation, and a translation of the stored content, and the sharing of the AR content linked to the virtual space may include augmenting and displaying the AR content linked to the space based on the authored tracking information.

According to still another aspect, the linking of the AR content to the virtual space may include storing translation information including at least two spaces to which the authored content is translated, and the sharing of the AR content linked to the virtual space may include augmenting and displaying the AR content linked to the space based on the authored tracking information.

According to still another aspect, the linking of the AR content to the virtual space may include setting a sharing target range for the space or the AR content.

According to still another aspect, the linking of the AR content to the virtual space may include setting a display condition that includes a time-by-time display status or a display type for the AR content.

According to still another aspect, the sharing of the AR content linked to the virtual space may include using the space to which the unique coordinate value is assigned as at least one of a space for sharing point of interest (POI) information, a space for sharing landmark information, a space for recommending location-based content, and a space for sharing location information.

According to still another aspect, the sharing of the AR content linked to the virtual space may include providing AR content linked to a corresponding space as content on a web using a coordinate system based on the coordinate value assigned to the space.

According to still another aspect, the sharing of the AR content linked to the virtual space may include augmenting and displaying AR content linked to a corresponding space on an AR space that includes the space.

According to still another aspect, the sharing of the AR content linked to the virtual space may include providing a notification of sharing the space and route information for a navigation to the space.

According to still another aspect, the sharing of the AR content linked to the virtual space may include augmenting and displaying AR content linked to a corresponding space on a map that includes a location corresponding to the space.

According to still another aspect, the sharing of the AR content linked to the virtual space may include sharing AR content linked to a corresponding space through interaction with a community related to the space.

According to still another aspect, the sharing of the AR content linked to the virtual space may include selecting and displaying partial content of the AR content linked to the space based on a selection criterion according to a display condition set for content, a category, an up-to-date feature, the popularity of content, a number of requested contents, and a search condition.

According to at least one example embodiment, there is provided a computer program, stored on a non-transitory computer-readable record medium, for executing the information sharing method described above on a computer in conjunction with the computer.

According to at least one example embodiment, there is provided a non-transitory computer-readable record medium storing a program for executing the information sharing method described above on a computer.

According to at least one example embodiment, there is provided a computer system including at least one processor configured to execute computer-readable instructions included in a memory. The at least one processor includes a space creator configured to create a virtual space by assigning a unique coordinate value to a location specified by an electronic device; a content linker configured to link augmented reality (AR) content to the virtual space; and a space sharer configured to share the AR content linked to the virtual space through the coordinate value of the virtual space.

According to some example embodiments, it is possible to provide an information platform for spatial messaging and content sharing in combination with augmented reality (AR) and localization.

According to some example embodiments, it is possible to create a virtual space having a unique coordinate value, to link AR content to the corresponding virtual space, and to share the space with users.

### BRIEF DESCRIPTION OF DRAWINGS

FIG. 1 is a diagram illustrating an example of a network environment according to an example embodiment.

FIG. 2 is a block diagram illustrating a configuration of an electronic device and a server according to an example embodiment.

FIG. 3 is a block diagram illustrating components includable in a processor of a server according to an example embodiment.

FIG. 4 is a flowchart illustrating a method performed by a processor of a server according to an example embodiment.

FIGS. 5 to 7 illustrate examples of a process of coordinating a space according to an example embodiment.

FIGS. 8 to 11 illustrate examples of a service screen for sharing content through a coordinated space according to an example embodiment.

### DETAILED DESCRIPTION OF THE INVENTION

Hereinafter, example embodiments of the present invention will be described with reference to the accompanying drawings.

An information sharing method according to example embodiments may be performed through a computer apparatus, such as an electronic device or a server, which is described below. Here, a computer program according to example embodiments may be installed and executed on the computer apparatus, and the computer apparatus may perform the information sharing method according to the example embodiments under control of the executed computer program. The computer program may be stored in a non-transitory computer-readable record medium to perform the information sharing method on a computer in conjunction with the computer apparatus. For example, the server may serve as an information platform for information sharing, and particularly, may share augmented reality (AR) content with users by creating a virtual space having a unique coordinate value and by linking the AR content to the corresponding space.

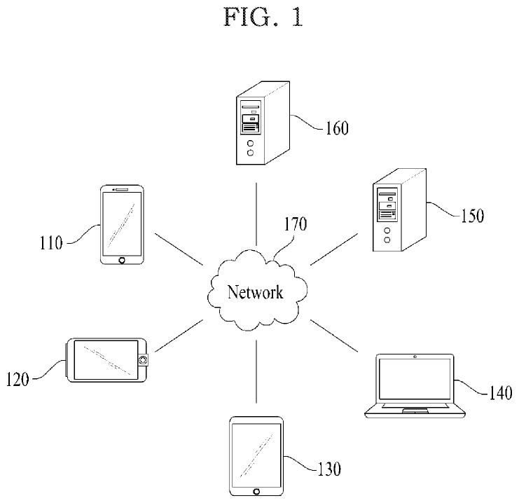

FIG. 1 is a diagram illustrating an example of a network environment according to one example embodiment. Referring to FIG. 1, the network environment includes a plurality of electronic devices 110, 120, 130, 140, a plurality of servers 150, 160, and a network 170. FIG. 1 is provided as an example only and thus, a number of electronic devices or a number of servers are not limited thereto.

Each of the plurality of electronic devices 110, 120, 130, 140 may be a fixed terminal or a mobile terminal configured as a computer apparatus. For example, the plurality of electronic devices 110, 120, 130, 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an AR device, and the like. For example, although FIG. 1 illustrates a shape of a smartphone as an example of the electronic device (1) 110, the electronic device (1) 110 may refer to one of various physical computer apparatuses capable of communicating with other electronic devices 120, 130, 140, and/or the servers 150, 160 over the network 170 in a wireless communication manner or in a wired communication manner.

The communication scheme is not particularly limited and may include a communication method using a near field communication between devices as well as a communication method using a communication network, for example, a mobile communication network, the wired Internet, the wireless Internet, a broadcasting network, a satellite network, etc., which may be included in the network 170. For example, the network 170 may include at least one of network topologies that include, for example, a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, it is provided as an example only and the example embodiments are not limited thereto.

Each of the servers 150, 160 may be configured as a computer apparatus or a plurality of computer apparatuses that provides instructions, codes, files, contents, services, and the like, through communication with the plurality of electronic devices 110, 120, 130, 140 over the network 170. For example, the server 150 may be a system that provides a first service to the plurality of electronic devices 110, 120, 130, 140 connected over the network 170. The server 160 may be a system that provides a second service to the plurality of electronic devices 110, 120, 130, 140 connected over the network 170. In detail, for example, the server 150 may provide a service, for example, an information sharing service, desired by a corresponding application to the plurality of electronic devices 110, 120, 130, 140, as the first service through the application as a computer program installed and executed on the plurality of electronic devices 110, 120, 130, 140. As another example, the server 160 may provide, as the second service, a service that distributes a file for installing and executing the application to the plurality of electronic devices 110, 120, 130, 140.

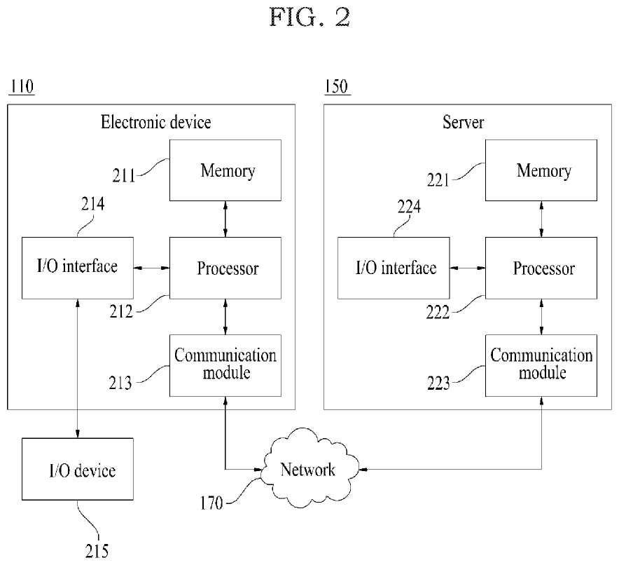

FIG. 2 is a block diagram illustrating an example of an electronic device and a server according to at least one example embodiment. FIG. 2 illustrates a configuration of the electronic device (1) 110 as an example for a single electronic device and illustrates a configuration of the server 150 as an example for a single server. The same or similar components may be applicable to other electronic devices 120, 130, 140, or the server 160.

Referring to FIG. 2, the electronic device (1) 110 may include a memory 211, a processor 212, a communication module 213, and an input/output (I/O) interface 214, and the server 150 may include a memory 221, a processor 222, a communication module 223, and an I/O interface 224. Where appropriate, descriptions of the components with the same name in the electronic device (1) 110 and the server 150 may be provided as being directed to a single component. It should be understood, however, that these components may perform the described functions separately in their respective electronic device (1) 110 or the server 150.

The memory 211, 221 may include a permanent mass storage device, such as random access memory (RAM), a read only memory (ROM), a disk drive, a solid state drive (SSD), and a flash memory, as a non-transitory computer-readable record medium. The permanent mass storage device, such as ROM, SSD, flash memory, and disk drive, may be included in the electronic device (1) 110 or the server 150 as a permanent storage device separate from the memory 211, 221. Also, an OS or at least one program code, for example, a code for a browser installed and executed on the electronic device (1) 110 or an application installed and executed on the electronic device (1)110 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication module 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, which provides an installation file of the application.

The processor 212, 222 may be configured to process computer-readable instructions of a computer program by performing basic arithmetic operations, logic operations, and I/O operations. The computer-readable instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the electronic device (1) 110 and the server 150 over the network 170 and may provide a function for communication with another electronic device, for example, the electronic device (2) 120 or another server, for example, the server 160. For example, the processor 212 of the electronic device (1) 110 may transfer a request created based on a program code stored in the storage device, such as the memory 211, to the server 150 over the network 170 under the control of the communication module 213. Inversely, a control signal, an instruction, content, a file, etc., provided under the control of the processor 222 of the server 150 may be received at the electronic device (1) 110 through the communication module 213 of the electronic device (1) 110 by going through the communication module 223 and the network 170. For example, a control signal, an instruction, content, a file, etc., of the server 150 received through the communication module 213 may be transferred to the processor 212 or the memory 211, and content, a file, etc., may be stored in a record medium, for example, the permanent storage device, further includable in the electronic device (1) 110.

The I/O interface 214 may be a device used for interfacing with an I/O device 215. For example, an input device of the I/O device 215 may include a device, such as a keyboard, a mouse, a microphone, and a camera, and an output device of the I/O device 215 may include a device, such as a display, a speaker, and a haptic feedback device. As another example, the I/O interface 214 may be a device for interfacing with an apparatus in which an input function and an output function are integrated into a single function, such as a touchscreen. The I/O device 215 may be configured as a single device with the electronic device (1) 110. Also, the I/O interface 224 of the server 150 may be a device for interfacing with an apparatus (not shown) for input or output that may be connected to the server 150 or included in the server 150. In detail, when processing instructions of the computer program loaded in the memory 211, the processor 212 of the electronic device (1) 110 may display a service screen configured using data provided from the server 150 or the electronic device (2) 120, or may display content on a display through the I/O interface 214.

According to other example embodiments, the electronic device (1) 110 and the server 150 may include a greater number of components than the number of components shown in FIG. 2. However, there is no need to clearly illustrate many components known in the related art. For example, the electronic device (1) 110 may include at least a portion of the I/O device 215, or may further include other components, for example, a transceiver, a global positioning system (GPS) module, a camera, a variety of sensors, a database (DB), and the like. In detail, if the electronic device (1) 110 is a smartphone, the electronic device (1) 110 may be configured to further include a variety of components, for example, an accelerometer sensor, a gyro sensor, a camera module, various physical buttons, a button using a touch panel, an I/O port, a vibrator for vibration, etc., which are generally included in the smartphone.

Hereinafter, example embodiments of a method and a system for creating a virtual space capable of linking AR content and making communication through the virtual space are described.

Here, proposed is a method of making a virtual space as an information platform by building a virtual wall through combination of AR and localization and by assigning a unique coordinate value for each individual location. A user may share content or a message of the user with another user through linkage to a specific three-dimensional (3D) space. Therefore, a universal global information system, such as a web, may be created by making a space of a real world as a virtual linkable space capable of linking a variety of information. Also, information on a specific space may be shared through interaction with the corresponding virtual space and also a web or a mobile system, using the unique coordinate value.

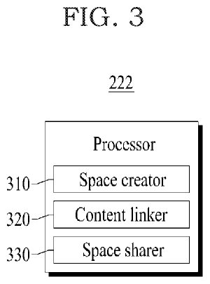

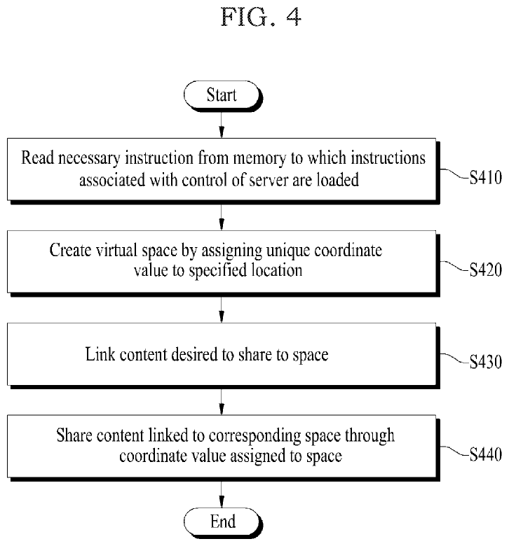

FIG. 3 is a block diagram illustrating an example of components includable in a processor of a server according to an example embodiment, and FIG. 4 is a flowchart illustrating a method performed by a processor of a server according to an example embodiment.

The server 150 according to the example embodiment may provide an information platform service for spatial messaging and content sharing through a combination of AR and localization, i.e., providing of unique coordinate values to a space or area of interest. That is, the server 150 serves as a platform that provides the plurality of electronic devices that are clients with an information sharing service based on virtual spaces. The server 150 may provide the space-based information sharing service through interaction with an application installed on the electronic devices 110, 120, 130, 140.

Referring to FIG. 3, to perform the information sharing method of FIG. 4, the processor 222 of the server 150 may include a space creator 310, a content linker 320, and a space sharer 330. Depending on example embodiments, the components of the processor 222 may be selectively included in or excluded from the processor 222. Also, depending on example embodiments, the components of the processor 222 may be separated or merged for representations of functions of the processor 222.

The processor 222 and the components of the processor 222 may control the server 150 to perform operations S410 to S440 included in the information sharing method of FIG. 4. For example, the processor 222 and the components of the processor 222 may be configured to execute an instruction according to a code of at least one program and a code of an OS included in the memory 221 of the server 150.

Here, the components of the processor 222 may be representations of different functions of the processor 222 performed by the processor 222 in response to an instruction provided from a program code stored in the server 150. For example, the space creator 310 may be used as a functional representation of the processor 222 that controls the server 150 to create a virtual space having a unique coordinate value in response to the instruction.

Referring to FIG. 4, in operation S410, the processor 222 may read a necessary instruction from the memory 221 to which instructions associated with control of the server 150 are loaded. In this case, the read instruction may include an instruction to control the processor 222 to perform the following operations S420 to S440.

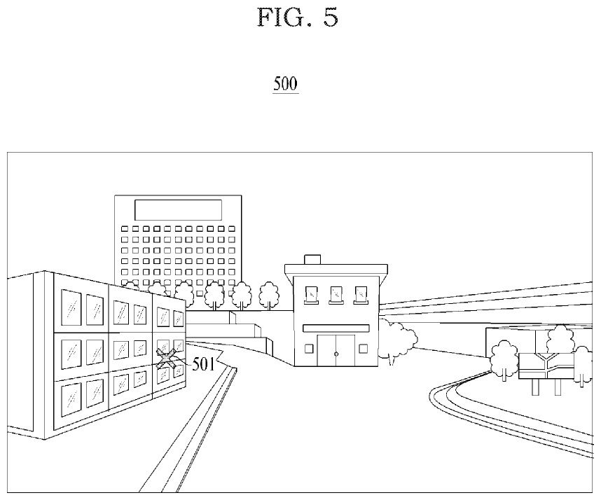

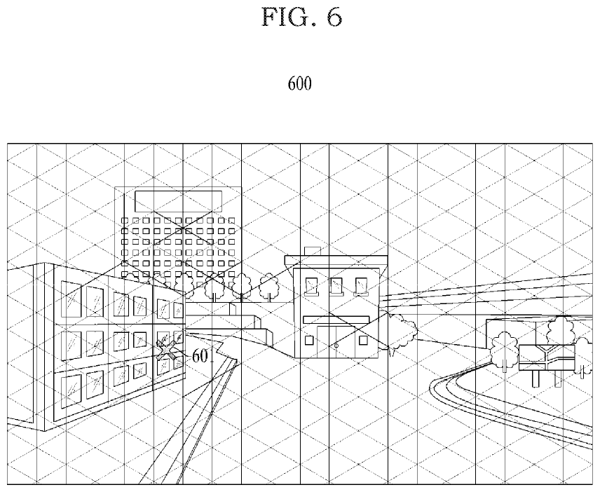

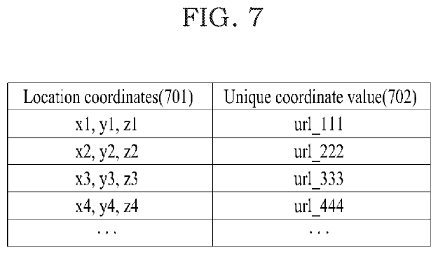

In operation S420, the space creator 310 may create a virtual space by assigning a unique coordinate value to a specified location. The space creator 310 may build a space, such as a virtual wall, in a real world specified by the electronic device (1) 110 and may assign a unique coordinate value to each individual space. The specified location may refer to a location specifiable by the electronic device (1) 110, such as, for example, a location selected by a user of the electronic device (1) 110, the current location of the user recognized through interaction with the electronic device (1) 110, a location pointed by a camera of the electronic device (1) 110, and the like. The unique coordinate value may refer to address information for identifying a space, such as, for example, Internet address information (a uniform resource locator (URL)). For example, referring to FIG. 5, the space creator 310 may assign a unique coordinate value to a location 501 in an area 500 in real space specified by the user and thereby create a virtual space at the corresponding location 501. For example, referring to FIG. 6, if a 3D map 600 for a real world is constructed, the space creator 310 may verify 3D coordinates (x, y, z) corresponding to a specific location 601 based on the 3D map 600 and may assign a unique coordinate value representing a virtual space to the corresponding location 601. 3D coordinates may be constructed at different levels based on mapping precision and may be subdivided based on centimeter (cm) or less, that is, a point cloud unit on a high-precision map. Referring to FIG. 7, the space creator 310 may assign a unique coordinate value 702 for each set of location coordinates 701 subdivided on a 3D map, that is, for each mapping point, and may use a corresponding location as a space capable of linking content of the user. Also, the space creator 310 may group point clouds based on a preset minimum unit and may assign a unique coordinate value for each grouped unit. For example, the space creator 310 may group mapping points based on a unit of 5 cm and may assign a unique coordinate value to each group. The unique coordinate value 702 may be assigned in advance for each set of location coordinates 701 as shown in FIG. 7 and, without directly visiting a specific location, the user may select a corresponding location and may create a virtual space at the selected location. As another example, the space creator 310 may verify the current location of the electronic device (1) 110 based on a global positioning system (GPS) module or an inertial measurement unit (IMU) of the electronic device (1) 110 and may verify and coordinate a specific location through a deep learning-based vision technology. For example, the space creator 310 may couple learning information, such as a specific shape (e.g., an appearance of a shop, a signboard, etc.) of a landmark or a point of interest (POI) with a GPS-based location and may calculate a unique value of the specific location to which the user desires to link content. Therefore, the space creator 310 may create the virtual space having the unique coordinate value at the specific location through localization of the space. In addition to a map mapping method, any technology capable of verifying a location, such as a GPS, wireless fidelity (WiFi), fingerprint, a visual positioning system (VPS), and a POI, may apply to the localization of the space.

Referring again to FIG. 4, in operation S430, the content linker 320 may link content desired to share with another user to the space created in operation S420. Here, the content may inclusively indicate any type of information representable in AR, such as, for example, a sticker, a text, an image, and a video. The content linker 320 may link the content to the virtual space by storing a parameter of content authored by the user through an authoring function provided from the server 150 in association with the coordinate value assigned to the space. The content created through the authoring function refers to AR content and is provided in a variously controllable form based on 6 degrees of freedom (6DoF), for example, motion, rotation, and translation. Here, motion, rotation, and translation of content controlled by the user may be stored in the server 150 with a default value of the content as tracking information. When another user shares the corresponding content, a form authored by an original user or control content may be included and reproduced based on tracking information of the content. Also, the content linker 320 may fixedly link content to a single virtual space and may also link the content to at least two virtual spaces while accessing the at least two spaces and may store translation information on the space with a default value of the content. For example, AR content desired to share while accessing a plurality of points, such as a marriage proposal and a local tour guide, may include translation information including at least two spaces. The content linker 320 may set a sharing target range for content. For example, the content linker 320 may set the sharing target range to be public without limiting a sharing target or may set the sharing target range to be private by limiting the sharing target to a portion of users, for example, the very user, a friend or a neighbor, and the like. The sharing target range may be set for each piece of content and also may be set for the entire contents linked to a virtual space for each space during a space creation process. Also, the content linker 320 may set a display condition for content. For example, the content linker 320 may separately set a content display status or display type for each time zone. For example, the content linker 320 may set a color of content to be differently represented during day and at night or may set content to be displayed only in evening hours and to not be displayed in other hours. In addition, the display condition may include a targeting setting, such as age, sex, and location.

In operation S440, the space sharer 330 may share the content linked to the corresponding space through the unique coordinate value assigned to the virtual space. That is, the space sharer 330 may share the content on the virtual space between users through the coordinated space. Here, the content to be shared may be provided as content on a web using a coordinate system as well as an AR-based service environment. Information on the virtual space may be shared through interaction with a map service or a community, such as, for example, a blog and a café. For example, the space sharer 330 may use the coordinated space as a virtual space for sharing POI information. For example, the space sharer 330 may link evaluations, reviews, spot photos, etc., on a restaurant to a corresponding virtual space through a content template provided from an authoring function and may share the same with other users. Also, an owner may directly link promotion information on a spot of the owner and corresponding owner information may be displayed using a separate user interface (UI) through authentication. As another example, the space sharer 330 may use a coordinated space as a virtual space for sharing landmark information. For example, a user may log in on a map as a visit record of the user by linking a photo or authentication related content at a time of visiting a destination and may consume the linked content at a time of revisiting the same destination. As another example, the space sharer 330 may use the coordinated space as a virtual space for recommending location-based content. The space sharer 330 may recommend content created in advance for a specific space, such that users visiting a corresponding location may use the content. For example, the space sharer 330 may provide the pre-made Turtle Ship AR content to a user visiting the Admiral Yi Sun-sin at Gwanghwamun Square, such that the user may consume or edit the AR content to use it. As another example, the space sharer 330 may use the coordinated space as a virtual space for sharing specific location information in which meta information is absent. For example, the space sharer 330 may display a message at a point at which there is a lot of fish on a fishing ground such that other users may use the corresponding information, or may display a moving food truck or my location on a large scale festival to share with other users. As another example, the space sharer 330 may use content on the coordinated space as content on a web using a coordinate system. The space sharer 330 may augment and share coordinated space information on a two-dimensional (2D) map or a 3D map on the web. The space sharer 330 may share the content on the coordinated space through interaction with a specific community. The space sharer 330 may link the specific community related to the corresponding space to the coordinated space and may share the content on the virtual space through the corresponding community. For example, the space sharer 330 may create a virtual space at a location at which a sign event of a specific celebrity proceeds and may use content linked to the corresponding space as content of a fan café on the web through interaction with the fan café on the web. Therefore, the space sharer 330 may use the coordinated space as various types of spaces that allow communication between users. Here, content to be shared may be reproduced as is in a form authored or manipulated by the user not only on a virtual reality (VR) space but also at an AR location.

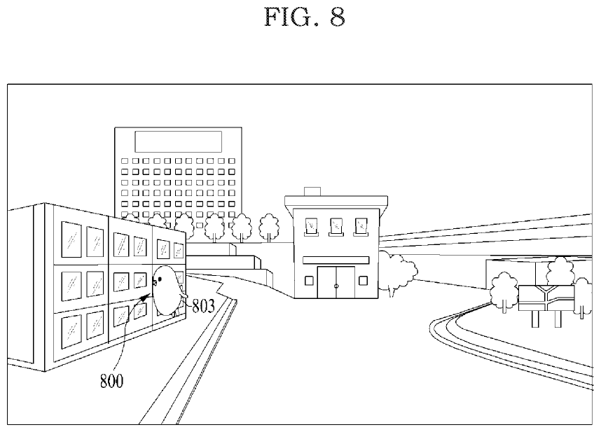

FIGS. 8 to 11 illustrate examples of a service screen for sharing content on a virtual space according to an example embodiment.

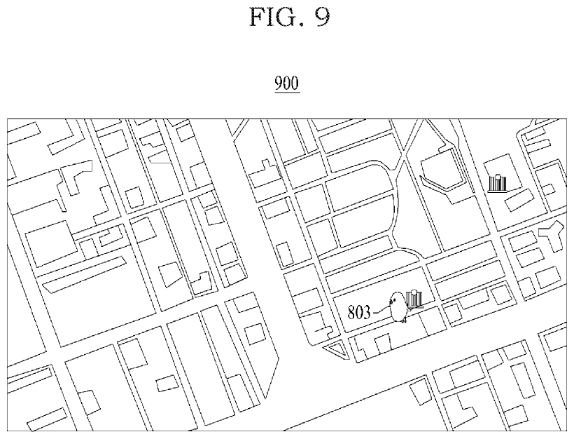

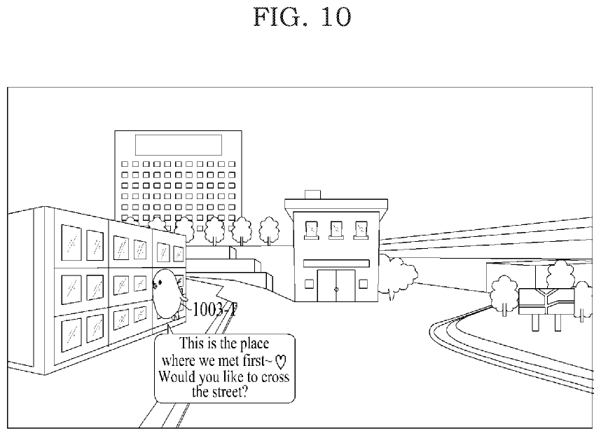

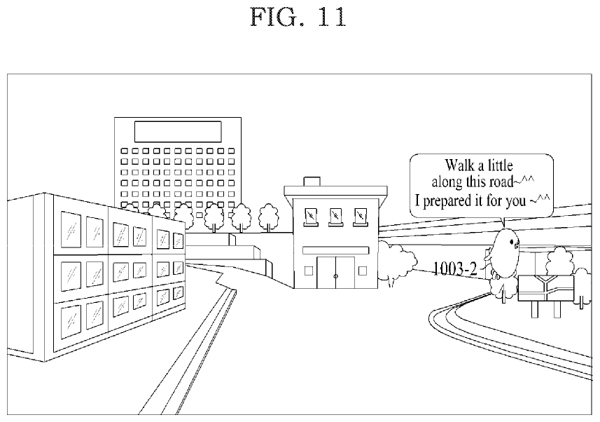

Referring to FIG. 8, a user A may create a virtual space S800 at a specific location and may upload AR content 803 on the virtual space S800 and may share the AR content 803 on the corresponding space S800 with a user B that visits the location corresponding to the space S800. The user B may view the content 803 uploaded by the user A to the space S800 through an exclusive application. For example, if the user B points to the virtual space S800 using a camera, the space sharer 330 may augment and display the content 803 uploaded by the user A to the space S800. As another example, the space sharer 330 may provide the user B with a notification of sharing the space S800 and route information for a navigation to the space S800, and, in response to an access from the user B to the space S800, may augment and display the content 803 uploaded by the user A to the space S 800. As another example, referring to FIG. 9, if the user B uses a map that includes a location corresponding to the space S800 through a 2D map (e.g., a vector, a street view, etc.) or a 3D map service on the web, the space sharer 330 may augment the content 803 uploaded by the user A to the space S800 and may display the augmented content 803 on a map screen 900. As another example, the space sharer 330 may share linked AR content while accessing at least two spaces. For example, referring to FIGS. 10 and 11, the user A may upload content by linking a plurality of spaces as a message for proposing to the user B, and if the user B accesses a corresponding place while sequentially accessing the uploaded spaces, the space sharer 330 may sequentially augment and display contents 1003-1 and 1003-2 uploaded by the user A. Here, in the case of content that includes translation information on the space, the space sharer 330 may also provide route information for a movement navigation between spaces.

If a number of users linking or authoring contents on the same space increases, a large amount of contents may be accumulated at a specific location and contents accumulated by many users on a specific space may exhibit history and characteristics of the corresponding location and real-time information. When displaying AR content using, for example, a 2D map, a 3D map, and a street view, many contents may not be simultaneously displayed due to spatial constraints. Therefore, technology for semantically filtering contents accumulated on a time axis on the space is required.

The space sharer 330 may select content to be displayed on the specific space based on a predetermined criterion. Here, a selection criterion may be selected automatically or may be selected by the user. For example, the space sharer 330 may select content to be displayed for the user based on a display condition (including a targeting setting) set to the content. As another example, the space sharer 330 may classify content into a preset category and may display content of a category selected by the user. As another example, the space sharer 330 may select and display popular content or content linked by a popular user based on content popularity or user popularity. As another example, the space sharer 330 may select and display a number of contents requested by the user based on an up-to-date feature, popularity, and the category of content. As another example, the space sharer 330 may select and display content corresponding to a search condition input from the user by providing a search function for content.

According to example embodiments, it is possible to coordinate a space and to use the coordinated space as a space for sharing content between users, such as, for example, a content platform.

The apparatuses described herein may be implemented using hardware components, software components, and/or a combination thereof. For example, the apparatuses and the components described herein may be implemented using one or more general-purpose or special purpose computers or processing devices, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied in any type of machine, component, physical equipment, computer storage medium or device, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in non-transitory computer-readable media. Here, the media may continuously store computer-executable programs or may transitorily store the same for execution or download. Also, the media may be various types of recording devices or storage devices in a form of one or a plurality of hardware components combined. Without being limited to media directly connected to a computer system, the media may be distributed over the network. Examples of the media include magnetic media such as hard disks, floppy disks, and magnetic tapes; optical media such as CD-ROMs and DVDs; magneto-optical media such as floptical disks; and hardware devices that are specially configured to store program instructions, such as read-only memory (ROM), random access memory (RAM), flash memory, and the like. Examples of other media may include record media and storage media managed by Appstore that distributes applications or a site that supplies and distributes other various types of software, servers, and the like.

While the example embodiments are described with reference to specific example embodiments and drawings, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. An information sharing method performed by a computer system, the information sharing method comprising:
creating a virtual space by assigning a unique coordinate value to a location specified by an electronic device;
linking augmented reality (AR) content to the virtual space; and
sharing the AR content linked to the virtual space through the coordinate value of the virtual space.

2. The information sharing method of claim 1, wherein the creating of the virtual space comprises verifying and coordinating the specified location through a map mapping method or a deep learning-based vision technology.

3. The information sharing method of claim 1, wherein the creating of the virtual space comprises assigning a unique coordinate value for each set of subdivided location coordinates of a map or grouping the location coordinates based on a desired unit and assigning the unique coordinate value for each grouped unit.

4. The information sharing method of claim 1, wherein the linking of the AR content comprises storing a parameter of content authored through an authoring function in association with the coordinate value assigned to the virtual space.

5. The information sharing method of claim 4, wherein the linking of the AR content comprises storing tracking information that includes a motion, a rotation, and a translation of the stored content, and
the sharing of the AR content comprises augmenting and displaying the AR content linked to the virtual space based on the authored tracking information.

6. The information sharing method of claim 4, wherein the linking of the AR content comprises storing translation information including at least two spaces to which the authored content is translated, and
the sharing of the AR content comprises augmenting and displaying the AR content linked to the virtual space based on the authored tracking information.

7. The information sharing method of claim 1, wherein the linking of the AR content comprises setting a sharing target range for the virtual space or the AR content.

8. The information sharing method of claim 1, wherein the linking of the AR content comprises setting a display condition that includes a time-by-time display status or a display type for the AR content.

9. The information sharing method of claim 1, wherein the sharing of the AR content comprises using the virtual space to which the unique coordinate value is assigned as at least one of a space for sharing point of interest (POI) information, a space for sharing landmark information, a space for recommending location-based content, and a space for sharing location information.

10. The information sharing method of claim 1, wherein the sharing of the AR content comprises providing AR content linked to a corresponding space as content on a web using a coordinate system based on the coordinate value assigned to the space.

11. The information sharing method of claim 1, wherein the sharing of the AR content comprises augmenting and displaying AR content linked to a corresponding space on an AR space that includes the virtual space.

12. The information sharing method of claim 11, wherein the sharing of the AR content comprises providing a notification of sharing the virtual space and route information for a navigation to the virtual space.

13. The information sharing method of claim 1, wherein the sharing of the AR content comprises augmenting and displaying AR content linked to a corresponding space on a map that includes a location corresponding to the virtual space.

14. The information sharing method of claim 1, wherein the sharing of the AR content comprises sharing AR content linked to a corresponding space through interaction with a community related to the virtual space.

15. The information sharing method of claim 1, wherein the sharing of the AR content comprises selecting and displaying partial content of the AR content linked to the virtual space based on a selection criterion according to a display condition set for content, a category, an up-to-date feature, and a popularity of content, a number of requested contents, and a search condition.

16. A non-transitory computer-readable record medium storing a program for executing an information sharing method, the program when executed by a computer instructing the computer to perform the steps comprising;
creating a virtual space by assigning a unique coordinate value to a location specified by an electronic device;
linking augmented reality (AR) content to the virtual space; and
sharing the AR content linked to the virtual space through the coordinate value of the virtual space.

17. A computer system comprising:
at least one processor configured to execute computer-readable instructions stored in a memory,
wherein the at least one processor comprises:
a space creator configured to create a virtual space by assigning a unique coordinate value to a location specified by an electronic device;
a content linker configured to link augmented reality (AR) content to the virtual space; and
a space sharer configured to share the AR content linked to the virtual space through the coordinate value of the virtual space.

18. The computer system of claim 17, wherein the space creator is configured to assign a unique coordinate value for each set of subdivided location coordinates of a map or to group the location coordinates based on a desired unit and assign the unique coordinate value for each grouped unit.

19. The computer system of claim 17, wherein the space sharer is configured to augment and display AR content linked to a corresponding space on an AR space that includes the virtual space or to provide AR content linked to a corresponding space as content on a web using a coordinate system based on the coordinate value assigned to the virtual space.
